(19) United States
(12) Patent Application Publication
(10) Pub. No.: US 2026/0138821 A1
(43) Pub. Date: May 21, 2026

(54) Gasket Assembly for a Trash Bin

(71) Applicants: Darcy Boemer, Saint Pauls (CA); Joseph Martin Boemer, Saint Pauls (CA)

(72) Inventors: Darcy Boemer, Saint Pauls (CA); Joseph Martin Boemer, Saint Pauls (CA)

(21) Appl. No.: 18/951,915

(22) Filed: Nov. 19, 2024

(51) Int. Cl. B65F 1/16

(52) U.S. Cl. CPC B65F 1/16; B65F 2001/1676; B65F 2210/167

(57) ABSTRACT

A gasket assembly for a trash bin is provided. The gasket is designed to attach to both the lid and the container body to form a seal and prevent the escape of odors and entry of insects. The gasket assembly includes a flat seal that fits on the perimeter of the container and a lid gasket that encircles the lid's perimeter. When the lid is closed, the lid gasket contacts the flat seal, forming an airtight barrier that restricts airflow into and out of the bin. This configuration slows down waste decomposition and maintains odor containment. The gasket is able to fit various roadside trash bins. Structural elements, such as an interior gasket and partitioned channels within the main body of the gaskets, support the integrity of the seal.

### BACKGROUND OF THE INVENTION

The present invention relates to seal devices. The present invention provides a flexible gasket assembly configured to secure onto roadside trash bins to prevent the escape of odors and entry of insects therefrom.

Roadside trash bins are commonly used for waste collection in residential and commercial areas. These bins are often exposed to a variety of environmental factors that can cause unpleasant odors to emanate and attract insects. Traditional trash bin designs do not adequately prevent airflow into or out of the container when the lid is closed, allowing the decomposition process to accelerate and release odors. This contributes to unsanitary conditions and reduces the effectiveness of waste management systems.

Existing solutions have focused on using various lid and container designs that attempt to improve the seal but fall short due to lack of universal adaptability and insufficient airtight features. Most current sealing methods are unable to create an airtight closure, leading to continued odor leaks and entry points for insects. These drawbacks compromise the hygiene of the waste containment process and limit the applicability of the solutions to specific bin models or types.

The present invention addresses these limitations by providing a universal gasket assembly that effectively creates an airtight closure between the lid and the container of a roadside trash bin. This seal slows the decomposition process by restricting airflow and retains unpleasant odors inside the bin while preventing insect access. The design is adaptable for use with various roadside trash bin configurations, offering an enhanced, practical, and reliable solution for waste management.

In light of the devices disclosed in the known art, it is submitted that the present invention substantially diverges in design elements and methods from the known art and consequently it is clear that there is a need in the art for an improvement for a gasket assembly for a trash bin. In this regard the instant invention substantially fulfills these needs.

### SUMMARY OF THE INVENTION

In view of the foregoing disadvantages inherent in the known types of gasket assemblies now present in the known art, the present invention provides a new gasket assembly configured to secure onto roadside trash bins to prevent the escape of odors and entry of insects therefrom.

It is an objective of the present invention to provide a gasket assembly for a trash bin comprising a flat seal positioned along the container's perimeter and a lid gasket that engages the flat seal upon closure, effectively restricting airflow. This structure helps to reduce the rate of waste decomposition by minimizing air exchange with the environment, thus containing odor within the trash bin and enhancing waste management.

It is an objective of the present invention to provide a gasket assembly for a trash bin comprising a double-layered sealing mechanism, where the lid gasket includes a main body with an enclosed channel that deforms upon contact with the flat seal. The deformation creates an airtight closure that significantly curtails the escape of unpleasant odors, maintaining a more sanitary and odor-free environment.

It is an objective of the present invention to provide a gasket assembly for a trash bin that is configured to universally adaptable to fit a variety of roadside trash bins. The invention is designed with dimensions and configurations that accommodate different bin models and sizes. Users can apply the gasket assembly to existing waste collection systems without the need for custom modifications.

It is an objective of the present invention to provide a gasket assembly for a trash bin wherein the main body of the lid gasket incorporates a structural partition that preserves the shape of the channel, maintaining a consistent sealing function over time. The gasket prevents deformation or loss of structural integrity from repeated opening and closing of the trash bin lid, thereby ensuring long-term effectiveness.

It is an objective of the present invention to provide a gasket assembly for a trash bin comprising a plurality of bottom flanges extend from the main body of the lid gasket to secure it firmly around the container, thereby stabilizing the gasket's position and preventing displacement during use. This contributes to the reliability of the airtight seal and ensures continued protection against odors and pests.

It is therefore an object of the present invention to provide a new and improved new a gasket assembly for a trash bin that has all of the advantages of the known art and none of the disadvantages.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings.

FIG. 1 shows a perspective view of an embodiment of the gasket for a trash bin, wherein the trash bin is in a closed configuration.

FIG. 2 shows a perspective view of an embodiment of the gasket assembly for a trash bin, wherein the trash bin is in an open configuration.

FIG. 3 shows a cross-section view of a lid gasket of the gasket assembly for a trash bin.

FIG. 4 shows a cross-section view of an embodiment of the gasket assembly for a trash bin.

FIG. 5 shows a cross-section view of an alternate embodiment of the gasket assembly for a trash bin.

### DETAILED DESCRIPTION OF THE INVENTION

Reference is made herein to the attached drawings. For the purpose of presenting a brief and clear description of the present invention, the preferred embodiment will be discussed as used for sealing the lid of a trash bin to the container. The figures are intended for representative purposes only and should not be considered to be limiting in any respect.

Reference will now be made in detail to the exemplary embodiment(s) of the invention. References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation. Further, repeated use of the phrase “in an embodiment” does not necessarily refer to the same embodiment.

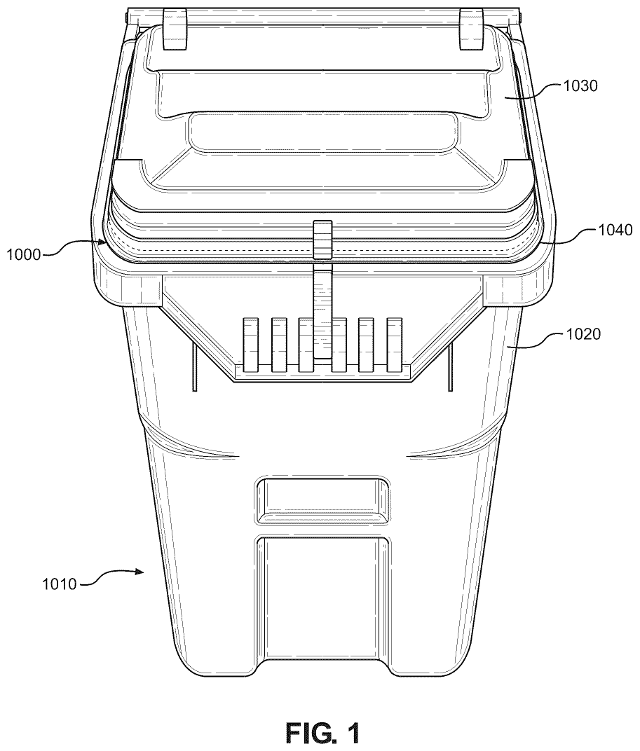

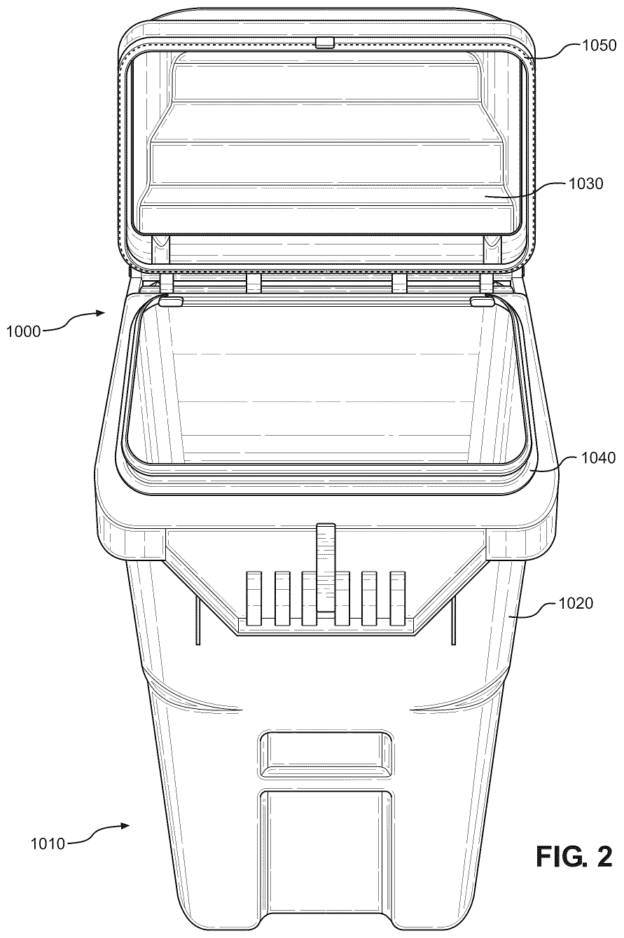

Referring now to FIGS. 1 and 2, there is shown a perspective view of an embodiment of the gasket assembly for a trash bin, wherein the trash bin is in a closed configuration and a perspective view of an embodiment of the gasket assembly for a trash bin, wherein the trash bin is in an open configuration, respectively. In the illustrated embodiment, the gasket assembly 1000 is configured to secure around the opening of a trash bin 1010. The trash bin 1010 comprises a container body 1020 and a lid 1030. The gasket assembly 1000 includes a flat seal 1040 adapted to be positioned on the perimeter of the container body 1020 and a lid gasket 1050 adapted to be disposed around the perimeter of the lid 1030. The flat seal 1040 rests flush on the container perimeter 1060, ensuring that it provides a stable sealing surface. In the illustrated embodiment, the flat seal 1040 comprises a rectangular shaped cross section. The flat seal 1040 is secured to the container 1020 via any suitable fastener, such as adhesive. When the lid 1030 is in a closed position, the contact between the lid gasket 1050 and the flat seal 1040 effectively seals off the interior of the container body 1020, limiting odor escape and pest entry.

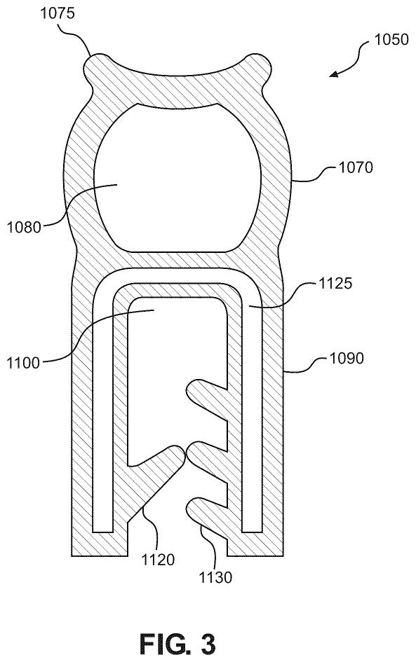

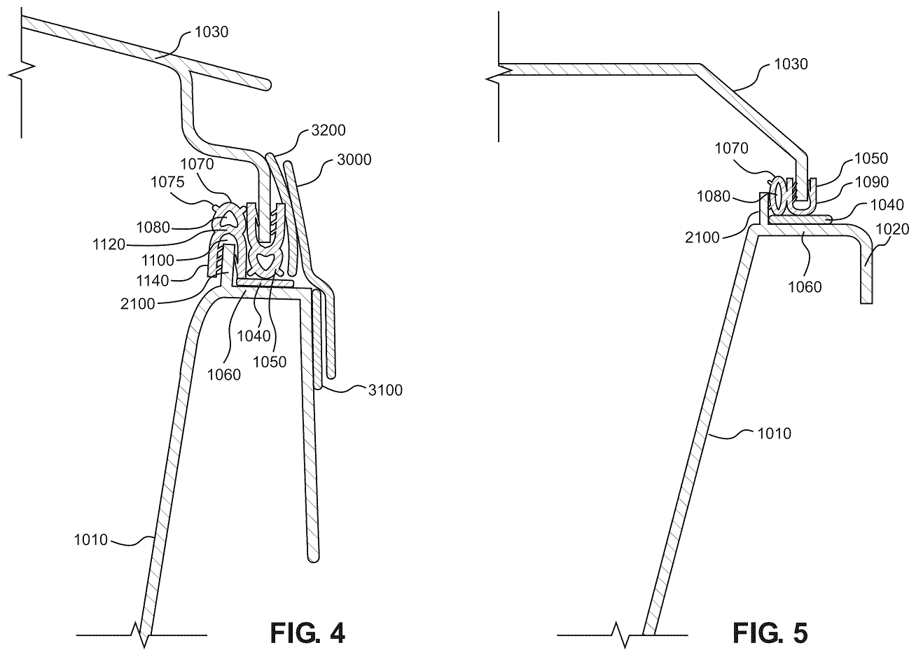

Referring now to FIGS. 3 and 4, there is shown a cross-section view of a lid gasket of the gasket assembly for a trash bin and a cross-section view of an embodiment of the gasket assembly for a trash bin, respectively. The lid gasket 1050 comprises a ring seal 1070 and a main body 1090, wherein the ring seal 1070 is bulbous and forms an enclosed channel 1080 configured to deform upon closure of the lid 1030 against the flat seal 1040. This deformation creates an airtight seal that prevents airflow from entering or escaping the trash bin 1010. In the illustrated embodiment, a pair of flexible tabs 1075 extend from an outer end of the ring seal 1070. The tabs 1075 are configured to help seal the lid to the container body by forming suction when the lid gasket 1050 is pressed against the flat seal 1040.

The lid gasket 1050 comprises a main body 1090 that extends around the entire perimeter of the lid 1030. The main body 1090 of the lid gasket 1050 extends outward from the ring seal 1070 and includes an open-ended hollow channel 1100 adapted to receive and conform securely around the perimeter of the lid 1030. In the illustrated embodiment, the ring seal 1070 extends from the closed end of the U-shaped main body 1090, wherein the closed end is opposite the open channel end. However, in alternate embodiments (such as seen in FIG. 5), the ring seal 1070 extends from a sidewall of the U-shaped main body, wherein the sidewall is perpendicular to the closed and open ends of the channel of the main body.

In the illustrated embodiment, the lid gasket 1050 includes a plurality of bottom flanges 1130 that extend inwardly within the open channel of the main body 1090. The flanges 1130 extend toward the ring seal 1070, wherein the flanges 1130 are configured to assist in holding the gasket 1050 securely around the lid 1030, preventing displacement and enhancing the stability of the seal when the trash bin 1010 is used. The flanges 1130 also contribute to maintaining consistent contact between the lid gasket 1050 and the flat seal 1040 when the lid 1030 is closed. In this way, the lid gasket 1050 is secured to the lid 1030 via a friction fit.

The main body 1090 of the lid gasket 1050 also includes a partition 1120 within the open channel 1100 to provide structural reinforcement. The partition 1120 is adapted to maintain the shape of the channel and prevents deformation that could compromise the integrity of the seal over repeated use. In the illustrated embodiment, the partition 1120 comprises a greater length than a flange disposed within the open channel. In some embodiments, as shown in FIG. 3, the main body of the lid gasket comprises a U-shaped hollow interior channel 1125 that permits the main body to have greater flexibility.

In FIG. 4, the illustrated embodiment comprises an interior gasket 1140 comprising a same shape as the lid gasket 1050. The interior gasket 1140 is disposed around an interior lip 2100 of the container 1020. The interior gasket 1140 includes a ring seal 1070 and a supporting main body 1090 that contacts the inner surface of the lid gasket 1050 when the trash bin is in a closed configuration. The dual-seal arrangement formed by the lid gasket 1050 and the interior gasket 1140 provides an additional layer of airtight protection, significantly reducing the possibility of odor leakage and ensuring the containment of waste within the bin.

In this embodiment, the flat seal 1040 remains positioned on the perimeter 1060 of the container body 1020 to serve as the initial contact surface for the lid gasket 1050. The lid gasket 1050 surrounds the perimeter of the lid 1030 and includes a main body 1090 that houses multiple integrated components designed to reinforce the sealing function. In the illustrated embodiment, the interior gasket 1140 contacts both the flat seal 1040 and the lid gasket 1050 when secured to the trash bin. The flat seal 1040 is positioned on the perimeter 1060 of the container body 1020 and forms a stable surface for engagement.

In the illustrated embodiment, a fastener 3000 removably secures the lid 1030 to the container body 1020. In the shown embodiment, the fastener 3000 comprises an upper section 3100, a lower section 3200 and a joining piece that selectively fastens to either the upper or lower section 3100, 3200. The fastener comprises any suitable fastening means, such as hook and loop material, a tie, snaps, or the like.

Referring now to FIG. 5, there is shown a cross-section view of an alternate embodiment of the seal gasket for a trash bin. In the illustrated embodiment, the ring seal 1070 of the lid gasket 1050 extends from a sidewall of the U-shaped main body, wherein the sidewall is perpendicular to the closed and open ends of the channel of the main body. This embodiment also comprises the plurality of flanges and a reinforced partition within the open channel 1100 that maintains the channel's shape under repeated compression. In operation, the ring seal 1070 forms a seal with the interior lip 2100 of the container body 1020.

In some embodiments, the gasket assembly is available as a standalone component, designed for easy attachment to existing trash bins. This configuration allows the gasket assembly 1000 to be retrofitted onto a variety of roadside trash bins, enhancing their sealing capabilities without requiring bin replacement. The flat seal features an adhesive backing, which enables it to securely attach to the perimeter of the container. This adhesive layer provides a reliable bond between the flat seal and the container, ensuring that the seal remains fixed in position during use. Once attached, the lid gasket aligns with the flat seal when the lid is closed, creating an airtight seal that prevents odor from escaping and air from entering the bin. The self-adhesive design of the flat seal simplifies the installation process, making the gasket assembly a practical, universal solution for improving waste containment.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A gasket assembly for a trash bin, comprising:
a flat seal having a first side and an opposing second side, wherein the first side is adapted to rest flush on a perimeter of a container of the trash bin;
a lid gasket configured to be disposed around a perimeter of a lid of the trash bin, wherein the lid gasket comprises a ring seal extending from a main body;
wherein the main body comprises a hollow channel with an open end adapted to receive the perimeter of the lid.
wherein the ring seal forms an enclosed channel configured to deform by expanding and pressing against the container;
wherein the lid gasket is configured to seal against the flat seal when the lid and container are in a closed configuration.

2. The gasket assembly of claim 1, further comprising an interior gasket configured to be positioned on an interior lip of the container, wherein the interior gasket includes a second ring seal and a second main body.

3. The gasket assembly of claim 2, wherein the interior gasket includes a second partition within the second main body configured to provide structural support and maintain a U-shape of a hollow channel thereof.

4. The gasket assembly of claim 3, wherein the ring seal extends from a closed end of the U-shaped main body, wherein the closed end is opposite the open channel end.

5. The gasket assembly of claim 4, wherein the second ring seal extends from a closed end of the second main body, wherein the closed end is opposite the open channel end.

6. The gasket assembly of claim 1, wherein the main body comprises a partition within the hollow channel configured to provide structural support and maintain a U-shape of the hollow channel.

7. The gasket assembly of claim 6, wherein the partition has a first end that extends from an interior wall of the hollow channel and an opposing second, free end.

8. The gasket assembly of claim 6, wherein the main body further comprises a plurality of flanges extending from the body in a direction opposite the partition, configured to help secure the lid gasket around the perimeter of the lid.

9. The gasket assembly of claim 8, wherein the plurality of flanges each have a first end extending from an interior wall of the hollow channel and a second, free end.

10. The gasket assembly of claim 8, wherein the partition comprises a greater length than the plurality of flanges.

11. The gasket assembly of claim 1, wherein the enclosed channel of the ring seal is adapted to deform to form an airtight seal between the lid gasket and the flat seal upon closure of the trash bin.

12. The gasket assembly of claim 1, wherein the flat seal is constructed from an elastic material capable of conforming to various perimeter shapes of containers, providing a universal fit for different roadside trash bin models.

13. The gasket assembly of claim 1, wherein the main body of the lid gasket is configured with a surface texture to enhance grip and facilitate the secure attachment of the gasket around the perimeter of the lid.

14. The gasket assembly of claim 1, further comprising a pair of flexible tabs extending from an outer end of the ring seal to create a suction effect upon closure.

15. The gasket assembly of claim 1, wherein the ring seal of the lid gasket extends from a sidewall of the U-shaped main body, wherein the sidewall is perpendicular to the closed and open ends of the hollow channel of the main body.

16. The gasket assembly of claim 1, further comprising trash bin having the container and the lid, wherein the flat seal is fastened to the container and the lid gasket is secured to the lid.

17. The gasket assembly of claim 1, further comprising a fastener configured to removably secure the lid to the container.

18. The gasket assembly of claim 1, wherein the flat seal comprises a solid core.

19. The gasket assembly of claim 1, wherein the ring seal and main body are formed from a single, monolithic member.

20. The gasket assembly of claim 1, wherein the ring seal is adapted to be compressed via a fastener to compress and form the seal.
